(19) United States
(12) Patent Application Publication
(10) Pub. No.: US 2024/0062646 A1
(43) Pub. Date: Feb. 22, 2024

(54) Corrective passive infrared sensor system

(71) Applicant: McWong Inc., Sacramento, CA (US)

(72) Inventor: Yan Zhou, Sacramento, CA (US)

(73) Assignee: McWong Inc., Sacramento, CA (US)

(21) Appl. No.: 18/445,440

(22) Filed: Aug. 17, 2023

Related U.S. Application Data
(60) Provisional application No. 63/474,506, filed on Aug. 17, 2022.

(51) Int. Cl. G08B 29/18; G08B 29/24

(52) U.S. Cl. CPC G08B 29/183; G08B 29/24

(57) ABSTRACT

A corrective PIR sensor system includes a PIR sensor circuit with a PIR sensor for controlling and electrical load circuit in response to occupancy detection. The PIR sensor is couples to an auxiliary sensor for measuring or monitoring one or more environmental condition. The corrective PIR sensor system also has a computing device connected to the PIR sensor and the auxiliary sensor for running corrective intelligent software or firm-wear to reduce false triggers of the PIR sensor circuit based on the environmental condition measured or monitored by the auxiliary sensor.

### RELATED APPLICATION

This application claims priority under 35 U.S.C. § 119(e) from the U.S. provisional patent application Ser. No. 63/474,506, filed on Aug. 17, 2022, and titled “CORRECTIVE PASSIVE INFRARED SENSOR SYSTEM”. The U.S. provisional patent application Ser. No. 63/474,506, filed on Aug. 17, 2022, and titled “CORRECTIVE PASSIVE INFRARED SENSOR SYSTEM” is hereby incorporated by reference.

### FIELD OF THE INVENTION

The invention relates occupancy sensors. More particularly, the present invention relates to sensors that correct detection parameters based on a measured condition.

### BACKGROUND OF THE INVENTION

A PIR sensor can detect changes in the amount of infrared radiation impinging upon it, which varies depending on the temperature and surface characteristics of the objects in front of the sensor. When an object, such as a person, passes in front of the background, such as a wall, the temperature at that point in the sensor's field of view will rise from room temperature to body temperature, and then back again. The sensor converts the resulting change in the incoming infrared radiation into a change in the output voltage, and this triggers the detection. Objects of similar temperature but different surface characteristics may also have a different infrared emission pattern, and thus moving them with respect to the background may trigger the detector as well.

One of the shortcoming of PIR sensors is that respond differently under different environmental conditions. For example, PIR sensors will respond differently depending on lighting conditions, temperature conditions, moisture conditions to name a few. In order to address some of the false signal some sensor system are configures with differential detection.

Differential detection uses pairs of sensor elements may be wired as opposite inputs to a differential amplifier. In such a configuration, the PIR measurements cancel each other so that the average temperature of the field of view is removed from the electrical signal; an increase of IR energy across the entire sensor is self-cancelling and will not trigger the device. This allows the device to resist false indications of change in the event of being exposed to brief flashes of light or field-wide illumination. (Continuous high energy exposure may still be able to saturate the sensor materials and render the sensor unable to register further information.) At the same time, this differential arrangement minimizes common-mode interference, allowing the device to resist triggering due to nearby electric fields. However, a differential pair of sensors cannot measure temperature in this configuration, and therefore is only useful for motion detection.

### SUMMARY OF INVENTION

The present invention is directed to corrective PIR sensor system that corrects or compensates sensing of a PIR sensor circuit with a PIR by using one or more auxiliary sensors to reduce false triggers that can occur by the PIR circuit. The one or more auxiliary sensors measuring or monitors one or more environmental conditions and a CPU or computing unit runs a corrective software or firm-ware or to improve the accuracy of the PIR sensor and PIR sensor circuit to open or close a load circuit.

Auxiliary sensors can include temperature sensors, CO 2 sensors, moisture sensors, CCD sensors or any other suitable sensors that can measure or monitor the one or more environmental conditions that can alter the sensitivity or accuracy of the PIR sensor circuit with a PIR sensor.

The CPU or computing unit commissioned or set to run corrective firmware or corrective software based on the type of auxiliary sensor or sensors that connected to the CPU or computing unit.

In accordance with the embodiments of the invention the CPU or computing unit is configured to automatically run diagnostic software or firmware to determine the type of auxiliary sensor or sensors that are connected to the CPU or computing unit and then the CPU or computing unit will commission or set to run the appropriate corrective software or corrective firm-ware based on the type of sensor or sensor that are determined to be connected to the CPU or computing unit. For example the system can automatically run a voltage curve on each of the connected auxiliary sensors. Because voltage curves are characteristic for each type of auxiliary sensor, the CPU or computing unit can use the measured voltage curve date to determine what type of auxiliary sensor or auxiliary sensors are connected to the CPU or computing unit and then commission or set the CPU or computing unit to execute the appropriate corrective software. This is one example of machine learning that the system is capable of. In addition to the machine learning described, the system can also collect historical data on auxiliary sensors and PIR sensor circuit to further self-correct or reduce the number of false triggers a PIR sensor circuit.

In further embodiments of the invention a control unit with the CPU or computing unit and an auxiliary sensor includes a switch that can be manually moved to select a type or types of auxiliary sensors are connected to the CPU or computing unit and set the CPU or computing unit to run the appropriate corrective software or firm-ware based on the selected location of the switch.

In accordance with yet further embodiments of the invention, the corrective PIR sensor system includes a light sensor to measure ambient light levels and a wind sensor (anemometer) to measure ambient wind levels. By measuring fluctuations in ambient light and ambient winds alone or along with any other environmental factors and using intelligent detection algorithms enables the modulation of detection sensitivity and results in a reduction in false or unnecessary activations of the PIR sensor.

### BRIEF DESCRIPTION OF THE DRAWINGS

FIG. 1 shows a schematic representation of a PIR sensor circuit with a PIR sensor connected to a corrective auxiliary sensor/CPU unit for controlling a load circuit, in accordance with the embodiments of the invention.

FIG. 2 shows a schematic representation of a PIR sensor circuit with a PIR sensor connected to a corrective auxiliary sensor/CPU unit with a switch for selecting one or more types of auxiliary sensors, in accordance with the embodiments of the invention.

FIG. 3 shows a block flow diagram for automatically determining one or more types of auxiliary sensors using the corrective system of the present invention.

### DETAILED DESCRIPTION OF THE INVENTION

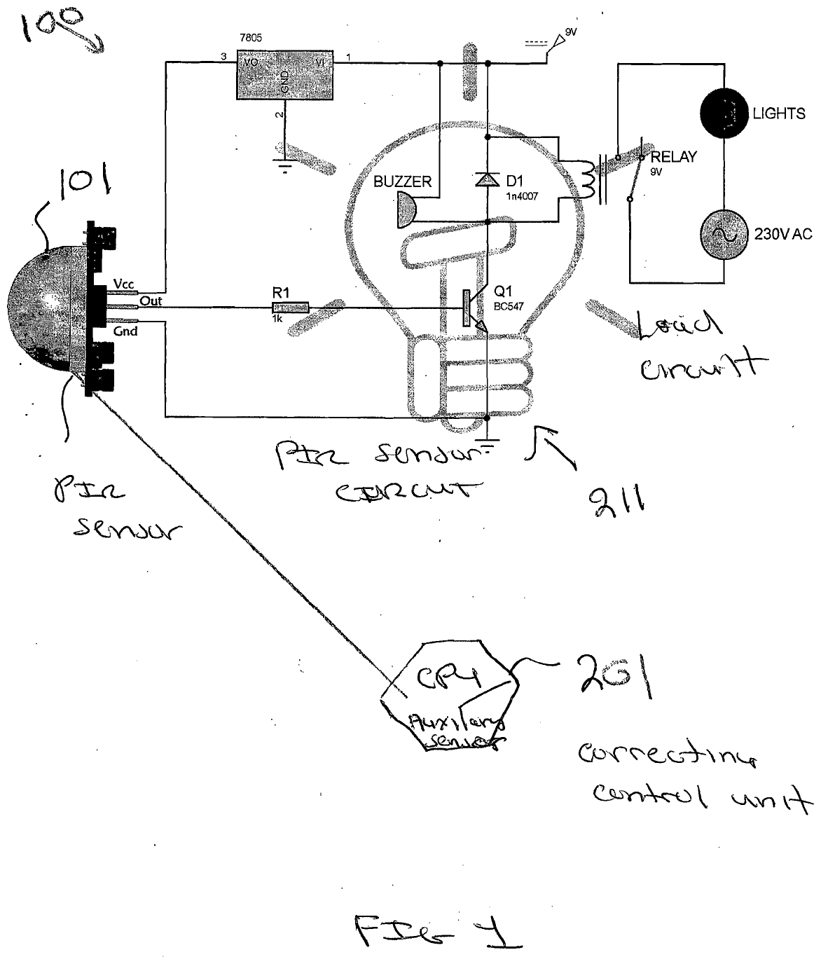

FIG. 1 shows a schematic representation 100 of a PIR sensor circuit 211 with a PIR sensor 101 connected to a corrective auxiliary sensor/CPU unit 201 for controlling a load circuit, in accordance with the embodiments of the invention.

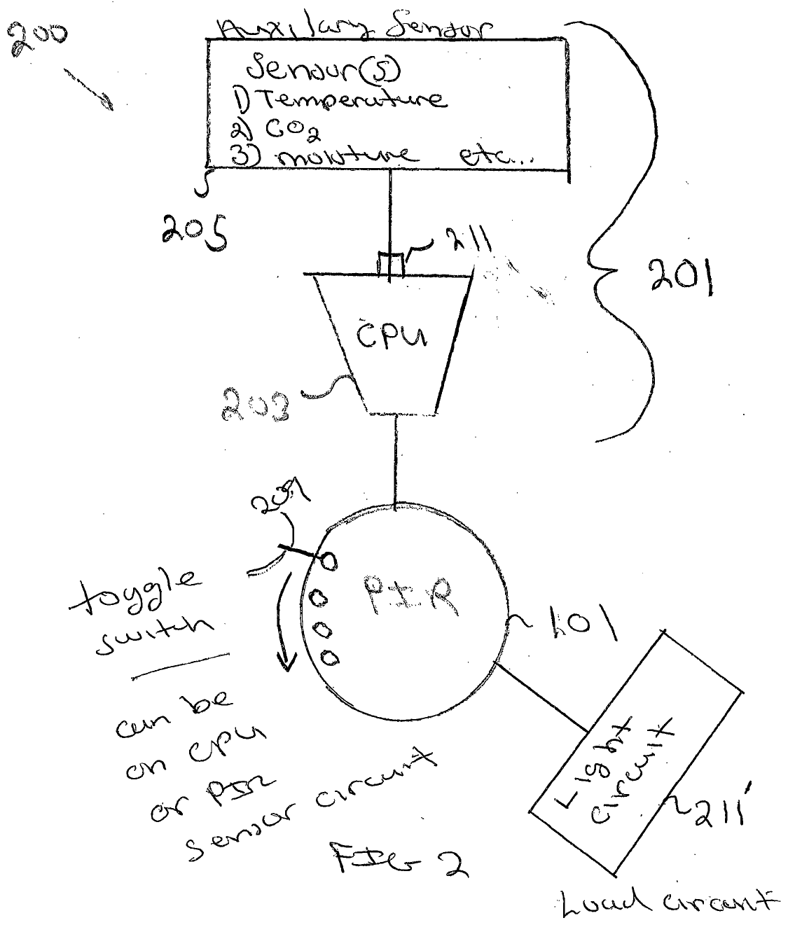

FIG. 2 shows a schematic representation 200 of a PIR sensor circuit 101 with a PIR sensor connected to a corrective auxiliary sensor/CPU unit 210 with a switch 209 for selecting one or more types of auxiliary sensors 205, that can include a temperature sensor, a CO2 sensor, a moisture sensor and/or an ambient light or an ambient wind sensor. The auxiliary sensor/CPU unit 210 includes a CPU 203 that is couples to the auxiliary sensor unit 205 through the appropriate connections 211 to run corrective software and reduce the number of false or unnecessary activations of the PIR sensor circuit 101 for turning on a light 211′.

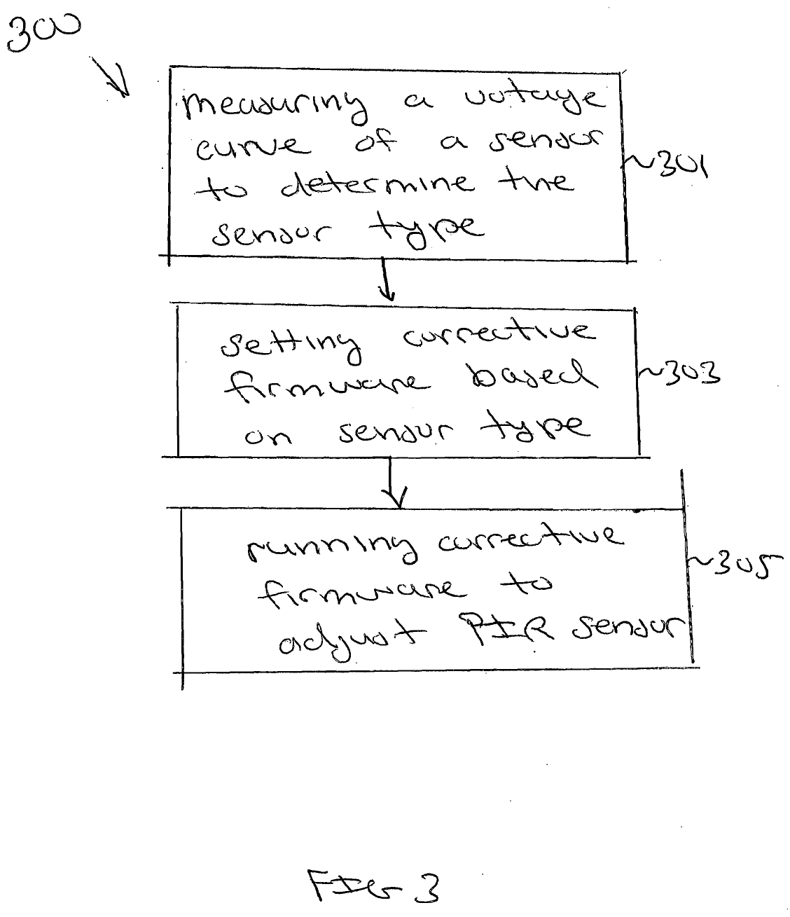

FIG. 3 shows a block flow diagram 300 for automatically determining one or more types of auxiliary sensors using the corrective system of the present invention. In the step 301, a voltage curve is measured to determine the type of auxiliary sensor that is being used to modulate the operation of the PIR sensor circuit. Then in the step 303 the corrective PIR sensor system selects the appropriate corrective or intelligent software to run, based on the type of senor that has been determined in the step 301. Then in the step 305 the appropriate corrective or intelligent software is executed to modulate the PIR sensor circuits to reduce the number of false or unnecessary activations of the PIR sensor circuit 101 for turning on a light 211′ (FIG. 2).

What is claimed is:

1. A system comprising:
a) a PIR sensor circuit with a PIR sensor for controlling and electrical load circuit in response to occupancy detection;
b) an auxiliary sensor for measuring or monitoring an environmental condition; and
c) computing device connected to the PIR sensor and the auxiliary sensor for running corrective software or firm-wear to reduce false triggers of the PIR sensor circuit based on the environmental condition measured or monitored by the auxiliary sensor.

2. A method comprising:
a) measuring a voltage curve of an auxiliary sensor with a CPU to determine a type of the auxiliary sensor;
b) commissioning the CPU to run corrective software or firm-wear based on the type of the auxiliary sensor determined by the voltage curve; and
c) running the corrective software or firm-wear to compensate triggering of PIR sensor circuit connected to the CPU based on an environmental condition measured or monitored by the auxiliary sensor.
